(19) United States
(12) Patent Application Publication
(10) Pub. No.: US 2006/0241213 A1
(43) Pub. Date: Oct. 26, 2006

(54) Crosslinkable Eleastomeric Composition and Method for Preparing the Composition

(76) Inventors: Maurizio Galimberti, Milano (IT); Michela Caprio, Avellino (IT); Stefano Testi, Monza (IT); Cristiano Puppi, Guanzate (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/533,293

(22) PCT Filed: Oct. 31, 2002
(86) PCT No.: PCT/EP02/12159

§ 371 Date: May 9, 2006

(51) Int. Cl. C08J 3/22

(52) U.S. Cl. 523/351; 264/211.21

(57) ABSTRACT

A crosslinkable elastomeric composition includes at least one thermoplastic polymer selected from amorphous polymers having a glass transition temperature higher than 80° C. or crystalline polymers having a melting temperature higher than 190° C. and at least one diene elastomeric polymer. A method for preparing the composition includes pre-mixing, at a temperature not lower than T_{g} or (Tₘ−20° C.), the at least one thermoplastic polymer with a first portion of the at least one diene elastomeric polymer to obtain a masterbatch and mixing the masterbatch with a remaining portion of the at least one diene elastomeric polymer. The composition may include from 1% to 65% of the at least one thermoplastic polymer and from 35% to 99% of the at least one diene elastomeric polymer. The at least one thermoplastic polymer may be dispersed in a form of particles having an average diameter not greater than 20 μm.

The present invention relates to a method for preparing a crosslinkable elastomeric composition.

More particularly, the present invention relates to a method for preparing a crosslinkable elastomeric composition, said elastomeric composition comprising at least one diene elastomeric polymer and at least one thermoplastic polymer.

The present invention also relates to an elastomeric composition comprising at least one diene elastomeric polymer and at least one thermoplastic polymer.

In the rubber industry, in particular that of tyres for vehicles wheels, the use of thermoplastic polymers in elastomeric compositions in order to improve their mechanical properties (both static and dynamic), has been described. The improvement of said mechanical properties, in particular of said dynamic mechanical properties, depending on the thermoplastic polymer used, allows to obtain tyres having either a low rolling resistance at the normal working temperatures (40° C.-70° C.) of the tyres or a good roadholding at higher temperatures following high thermomechanical stresses such as, for example, those derived from driving the vehicle under “hard handling” conditions.

For example, European patent application EP 117,834 describes a tyre with a tread band consisting of a sulphur-crosslinked elastomeric composition which includes a dispersion comprising from about 2 phr to about 15 phr, preferably from about 3 phr to about 10 phr, of a polystyrene resin in the form of particles with a softening point of between about 90° C. and about 120° C., preferably between about 90° C. and about 110° C. The presence of said polystyrene resin in the tread band of the tyre is said to increase the holding on wet surfaces while keeping the rolling resistance unchanged under the normal conditions of use, and to ensure holding under conditions of particularly high friction. In this respect, the following explanation is given. When the temperature of the tread band reaches 120° C.-150° C. or higher values, due to particularly high friction conditions, and thus temperature values above the softening point of the polystyrene resin, the outer part of the tread band softens and this is believed to allow an increase in traction and better roadholding of the tyre. On the other hand, during normal use of the tyre, up to temperatures of about 70° C., and thus temperature values below the softening point of the polystyrene resin, said resin remains passive and the tyre maintains low rolling resistance values.

European patent application EP 1,029,874 describes a polymer resin derived from the polymerization of limonene, dicyclopentadiene and t-butylstyrene, for use in elastomeric compositions for manufacturing tyre tread bands. The presence of said polymer resin in the tyre tread band is said to make it possible to obtain an increase in holding on dry surfaces without having an adverse effect on the durability of the tyre.

European patent application EP 1,063,246 describes a polymer resin derived from the polymerization of limonene, dimethyldicyclo-pentadiene, indene and vinyltoluene, for use in elastomeric compositions for manufacturing tyre tread bands. The presence of said polymer resin in the tyre tread band is said to make it possible to obtain an increase in the holding on dry surfaces without having an adverse effect on the durability of the tyre.

European patent application EP 1,050,547 describes a polymer resin derived from the polymerization of limonene and dimethyldicyclo-pentadiene for use in elastomeric compositions for manufacturing tyre tread bands. The presence of said polymer resin in the tyre tread band is said to make it possible to obtain an increase in the holding on dry surfaces without having an adverse effect on the durability of the tyre.

European patent application EP 754,571 describes a crosslinkable elastomeric composition comprising a polymer base containing a crosslinkable unsaturated chain and at least one organic compound which is solid at ambient temperature, said compound being substantially insoluble in the polymer base and having a first-order or second-order transition temperature of between 80° C. and 160° C. and an average molecular weight of between 10,000 and 1,000,000. Said organic compound is selected from polyphenylenether (such as, for example, Vestoran® 1100 from Huls), polyethylene, polypropylene, polymethyl methacrylate, polyvinyl alcohol, ethylene/vinyl alcohol copolymers, acrylo-nitrile/butadiene/styrene (ABS) terpolymers, ethylene/methacrylic acid copolymers, styrene/isoprene (SIS), styrene/butadiene (SBS), styrene/ethylene-butylene/styrene (S-E/B-S) and styrene/ethylene-propylene (S/E-P) block copolymers, or mixtures thereof. The abovementioned elastomeric composition may be used to prepare tread bands and is said to make it possible to obtain tyres with both low rolling resistance at the normal temperatures of use (40° C.-70° C.) and high roadholding when the tyre exceeds said temperatures due to high thermomechanical stresses.

U.S. Pat. No. 4,487,892 describes a rubber composition for use in tyres which comprises 1%-30% by weight of a non-crystallizable resinous polymer having a glass transition temperature (T_{g}) of not less than 110° C. and 70%-99% by weight of at least one rubber selected from styrene/butadiene copolymer rubber containing not more than 60% by weight of bound styrene, natural rubber, polybutadiene rubber having 1,4-configuration of not less than 80%, polybutadiene rubber having 1,2-configuration of not less than 50%, butyl rubber, halogenated butyl rubber and polyisoprene rubber having cis-1,4-configuration of not less than 90%. Said non-crystallizable resinous polymer is selected from: α-methylstyrene homopolymer, α-methylstyrene/styrene copolymer, nuclear-substituted styrene homopolymer, nuclear-substituted α-methylstyrene homopolymer, styrene-nuclear-substituted styrene copolymer, styrene-nuclear-substituted α-methylstyrene copolymer, and copolymers thereof containing a diene monomer. The abovementioned rubber composition may be used to prepare tread bands and is said to make it possible to obtain tyres having high driving performances, i.e. considerably improved controllability and stability during high-speed running.

U.S. Pat. No. 4,427,831 describes a rubber material comprising a mixture of an ordinary rubber and a powder of norbornene polymer which hardens at service temperature on ice and softens at higher temperatures and which does not lose its shape as a powder when heated during curing or shaping. Said ordinary rubber is selected from: butadiene rubber, styrene-butadiene rubber, isoprene rubber, or a natural rubber. The abovementioned rubber material may be formed into rubber articles such as tyres and shoes soles which have an excellent grip on ice.

U.S. Pat. No. 4,166,083 describes a rubber composition comprising (a) 70% to 90% by weight of at least one diene rubber, and (b) 30% to 5% by weight of a polymer or copolymer obtained by polymerizing at least one norbornene compound. The abovementioned rubber composition, which may be used in tyres manufacturing, is said to have—high green strength and improved tensile modulus, abrasion resistance and wet skid resistance.

However, the use of thermoplastic polymers in elastomeric compositions shows some drawbacks.

According to the Applicant's experience, the elastomeric compositions comprising thermoplastic polymers obtained according to the known techniques, does not satisfy the various requirements that render their use actually advantageous in the manufacture of cross-linked products, in particular in the manufacture of tyres. In particular, Applicant noticed that said thermoplastic polymers are not homogeneously dispersed in the elastomeric base: consequently, the resulting elastomeric compositions, because of formation of coarse particles having large dimensions (usually with an average diameter of about 100 μm or more), once crosslinked, show unsatisfactory mechanical properties, both static (in particular stress at break) and dynamic (in particular modulus and tandelta).

The Applicant has now found that it is possible to obtain a crosslinkable elastomeric composition comprising at least one thermoplastic polymer and at least one diene elastomeric polymer, capable of being advantageously used in the manufacture of crosslinked manufactured products, in particular in the manufacture of tyres, by using a thermoplastic polymer having a high glass transition temperature (e.g. higher than 80° C.) or a high melting temperature (e.g. higher than 190° C.) in the form of a masterbatch, said masterbatch being obtained by previously mixing said thermoplastic polymer with a portion of said diene elastomeric polymer. Subsequently, said masterbatch is added to the remaining portion of said diene elastomeric polymer obtaining a crosslinkable elastomeric composition which shows improved, both static and dynamic, mechanical properties.

According to a first aspect, the present invention thus relates to a method for producing a crosslinkable elastomeric composition comprising:
(a) at least one thermoplastic polymer selected from amorphous polymers having a glass transition temperature (T_{g}) higher than 80° C. or crystalline polymers having a melting temperature (Tₘ) higher than 190° C.;
(b) at least one diene elastomeric polymer;
said method comprising the following steps:
   pre-mixing said thermoplastic polymer (a) with a portion of said diene elastomeric polymer (b) to obtain a masterbatch, said pre-mixing step being carried out at a temperature not lower than T_{g} or not lower than (Tₘ−20° C.);
   mixing the masterbatch obtained in said pre-mixing step to the remaining portion of said diene elastomeric polymer (b).

Said glass transition temperature (T_{g}) and said melting temperature (Tₘ) may be determined by known techniques such as, for example, by DSC (Differential Scanning Calorimetry). Alternatively, said glass transition temperature (T_{g}) may be determined according to ISO standard 306 (Vicat point).

The abovementioned method may be carried out in continuously or discontinuously.

According to one preferred embodiment, in said pre-mixing step the portion of the diene elastomeric polymer (b) used is from 20% by weight to 90% by weight, preferably from 30% by weight to 50% by weight, with respect to the weight of the diene elastomeric polymer (b) present in the final crosslinkable elastomeric composition.

According to one preferred embodiment, said thermoplastic polymer (a) is present in the crosslinkable elastomeric composition in an amount of from 0.1 phr to 100 phr, preferably from 3 phr to 60 phr, even more preferably from 5 phr to 40 phr.

For the purposes of the present description and of the claims which follows, the term “phr” means the parts by weight of a given component of the elastomeric composition per 100 parts by weight of the diene elastomeric polymer.

According to one preferred embodiment, said pre-mixing step comprises:
feeding at least one thermoplastic polymer (a) into at least one extruder comprising a housing, at least one screw rotatably mounted in said housing including at least one feed opening and a discharge opening;
mixing said at least one thermoplastic polymer
(a) at a temperature not lower than T_{g} or not lower than (Tₘ−20° C.);
feeding at least one diene elastomeric polymer (b);
mixing said at least one diene elastomeric polymer (b);
dispersing said at least one thermoplastic polymer (a) into said at least one diene elastomeric polymer (b) to obtain a masterbatch;
extruding the obtained masterbatch through the discharge opening of said extruder.

Preferably, said extruder is a co-rotating twin-screw extruder.

Said masterbatch may be obtained in the form of a continuous ribbon or, alternatively, in the form of a subdivided product.

According to a preferred embodiment, said at least one thermoplastic polymer (a) is dispersed in said masterbatch in the form of particles having an average diameter not higher than 20 μm, preferably of between 8 μm and 18 μm.

According to a further aspect, the present invention relates to an elastomeric composition comprising:
from 1% to 65%, preferably from 10% to 40%, of at least one thermoplastic polymer (a), said thermoplastic polymer (a) being selected from amorphous polymers having a glass transition temperature (T_{g}) higher than 80° C. or crystalline polymers having a melting temperature (Tₘ) higher than 190° C.;
from 35% to 99%, preferably from 60% to 90%, of at least one diene elastomeric polymer (b);
   wherein said at least one thermoplastic polymer (a) is dispersed in said elastomeric composition in the form of particles having an average diameter not higher than 20 μm, preferably of between 8 μm and 18 μm.

According to one preferred embodiment the thermoplastic polymer (a) may be selected, for example, from: cycloolefin polymers, poly(phenylene ethers), styrene-based polymers, polyesters, polyamides, polyimides, polycarbonates, polysulfones, polyvinylchlorides, polymethyl(metha)-acrylates, polyacrilonitriles, polyvinylpyrrolidones, aromatic polyketones, poly(alkylene oxides), aromatic polysulphides, perfluorurated polyalkylenes, or mixtures thereof. Cycloolefin polymers, poly(phenylene-ethers), styrene-based polymers and polyesters, are particularly preferred.

Cycloolefin polymers which may be used in the present invention may be selected, for example, from:
(b-1) a cycloolefin random copolymer obtained by copolymerizing (i) at least one aliphatic α-olefin and (ii) at least one cycloolefin represented by the following formula (I) and, optionally, (iii) a polyene;
(b-2) a ring-opening polymer of at least one cycloolefin represented by the following formula (I); and
(b-3) a hydrogenation product of a ring-opening polymer of at least one cyclolefin represented by the following formula (I): 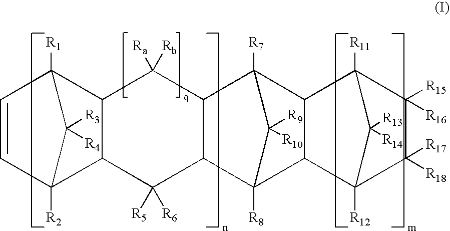
   wherein:
   n is 0 or a positive integer, preferably is 0 or 1;
   m is 0 or a positive integer;

q is 0 or 1;
R₁, R₂, R₃, R₄, R₅, R₆, R₇, R₈, R₉, R₁₀, R₁₁, R₁₂, R₁₃, R₁₄, R₁₅, R₁₆, R₁₇, R₁₈, Rₐ ed R_{b}, which may be equal or different from each other, represent a hydrogen atom, a halogen atom, or an aliphatic, an alicyclic or an aromatic hydrocarbon group;
R₁₅, R₁₆, R₁₇, R₁₈, may be linked each other to form a monocyclic or polycyclic group which may have double bonds; and
R₁₅ and R₁₆, or R₁₇ and R₁, may together form an alkylidene group.

The term “aliphatic α-olefin” generally means an olefin of formula CH₂═CH—R, in which R represents a hydrogen atom, a linear or branched alkyl group containing from 1 to 12 carbon atoms. Preferably, the aliphatic α-olefin is selected from: ethylene, propylene, 1-butene, isobutylene, 1-pentene, 1-hexene, 3-methyl-1-butene, 3-methyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 1-octene, 1-decene, 1-dodecene, 1-tetradecene, 1-hexadecene, 1-octadecene, 1-eicosene, or mixture thereof. Of these, preferred is ethylene or propylene, particularly preferred is ethylene.

Examples of the halogen atom include fluorine atom, chlorine atom, bromine atom and iodine atom.

Examples of the hydrocarbon group generally include alkyl group having from 1 to 20 carbon atoms, cycloalkyl group having from 3 to 15 carbon atoms, and aromatic hydrocarbon group having from 6 to 14 carbon atoms.

Specific examples of the alkyl group include methyl, propyl, isopropyl, amyl, octyl, decyl, dodecyl, octadecyl, these alkyl groups may be substituted with halogen atoms.

A specific example of the cycloalky™ group is cyclohexyl.

Specific examples of the aromatic hydrocarbon group include phenyl, naphthyl.

Moreover, in the above formula (I), R₁₅ and R₁₆, R₁₇ and R₁₈, R₁₅ and R₁₇, R₁₆ and R₁₈, R₁₅ and R₁₈, or R₁₆ and R₁₇, may be linked together to form a monocyclic or polyciclic group, optionally containing a double bonds.

Examples of the monocyclic or polyciclic group are the following: 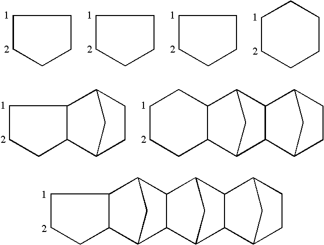
wherein carbon atoms attached with numerals 1 and 2 are those to which substituent R₁₅ or R₁₆ and R₁₇ or R₁₈ are linked respectively.

In the above formula (I), R₁₅ and R₁₆ or R₁₇ and R₁₈ may together form an alkylidene group. This alkylidene group generally has from 2 to 20 carbon atoms and, examples of such alkylidene group include ethylidene, propylidene, isopropylidene.

In the above formula (I), when q is 1, the corresponding ring is a 6-membered ring and, when q is 0, the corresponding ring is a 5-membered ring.

Preferably, the cycloolefin polymer (b) which may be used in the present invention may be selected from copolymers of a cyclic olefin having a norbornene-based structure (preferably norbornerie, tetracyclododecene or cyclic olefins—having a structure derived from them), and an aliphatic α-olefin (preferably ethylene or propylene). Among them, norbornene-ethylene copolymer, norbornene-propylene copolymer, tetracyclododecene-ethylene copolymer, tetracyclododecene-propylene copolymer, are particularly preferred. More particularly, norbornene-ethylene copolymer is preferred.

With reference to a cycloolefin random copolymer (b-1), the term “polyene” generally means a conjugated or non-conjugated diene, triene or tetraene. When a diene comonomer is present, this comonomer generally contains from 4 to 20 carbon atoms and is preferably selected from: linear conjugated or non-conjugated diolefins such as, for example, 1,3-butadiene, 1,4-hexadiene, 1,6-octadiene; monocyclic or polycyclic dienes such as, for example, 1,4-cyclohexadiene, 5-ethylidene-2-norbornene, 5-methylene-2-norbornene, vinylnorbornene, or mixtures thereof. When a triene or tetraene comonomer is present, this comonomer generally contains from 9 to 30 carbon atoms and is preferably selected from trienes or tetraenes containing a vinyl group in the molecule or a 5-norbornen-2-yl group in the molecule. Specific examples of triene or tetraene comonomers which may be used in the present invention are: 6,10-dimethyl-1,5,9-undecatriene, 5,9-dimethyl-1,4,8-decatriene, 6,9-dimethyl-1,5,8-decatriene, 6,8,9-trimethyl-1,6,8-decatriene, 6,10,14-trimethyl-1,5,9,13-pentadecatetraene, or mixture thereof. Preferably, the polyene is a diene.

Usually, the cyclolefin polymer (b) as described above, has an intrinsic viscosity [α]as measured in decalin at 135° C., of from 0.01 dl/g to 10 dl/g, preferably from 0.05 dl/g to 5 dl/g, more-preferably 0.3 dl/g to 2 dl/g.

The cycloolefin random copolymer (b-1) generally has the following composition: 40 mol %-85 mol %, preferably 42 mol %-80 mol %, of an aliphatic α-olefin; 15 mol %-60 mol %, preferably 20 mol %-58 mol % of a cycloolefin having formula (I); 0 mol %-10 mol %, preferably 0 mol %-2 mol %, of a polyene.

The random cycloolefin copolymers (b-1), (b-2) e (b-3) may be synthesized by using any polymerization technique known in the art. Examples of said techniques are disclosed, for example, in the following U.S. patents: U.S. Pat. No. 5,494,969, U.S. Pat. No. 5,741,869 and U.S. Pat. No. 5,569,711.

Examples of cycloolefin random copolymers (b-1) which may be used in the present invention and which are currently commercially available are the products Topas® from Ticona. Poly(phenylene ethers) (PPE) which may be used in the present invention may be selected, for example, from thermoplastic engineering resins obtained by the oxidative coupling polymerization of alkyl substituted phenols. Examples of said thermoplastic engineering resins include poly(2,6-dialkyl-1,4-phenylene ethers) such as, for example, poly(2,6-dimethyl-1,4-phenylene ether), poly(2-methyl-6-ethyl-1,4-phenylene ether), poly(2,6-dipropyl-1,4-phenylene ether), poly(2-ethyl-6-propyl-1,4-phenylene ethers), or mixtures thereof.

Examples of poly(phenylene)ethers which may be used in the present invention and which are currently commercially available are the products Vestoran® from Degussa Huls.

Styrene-based polymers which may be used in the present invention may have atactic, syndiotactic or isotactic configuration. Examples of said styrene-based polymers are: polystyrene, poly(alkylstyrene), poly(halogenated styrene), poly(halogenated alkylstyrene), poly(alkoxystyrene), poly(vinyl benzoate), hydrogenated polymer thereof, or mixtures thereof. The poly(alkylstyrene) includes poly(methylstyrene), poly(ethylstyrene), poly(iso-propylstyrene), poly(t-butylstyrene), poly(phenyl-styrene), poly(vinylnaphthalene), polyvinyl-(styrene), or mixtures thereof. Poly(halogenated styrene) includes poly(chlorostyrene), poly(bromo-styrene), poly(fluorostyrene), or mixtures thererof. The poly(halogenated alkylstyrene) includes poly(chloromethylstyrene). The poly(alkoxystyrene) includes poly(methoxystyrene), poly(ethoxystyrene), or mixtures thereof.

Examples of styrene-based polymers which may be used in the present invention and which are currently commercially available are the products Edistir® from Polimeri Europa and Questra® from Dow Plastic.

Polyesters which may be used in the present invention may be selected, for example, from the polymer reaction products of at least one aliphathic or aromatic polycarboxylic acid ester of anhydride and at least a diol. Examples of said polyesters are: poly(trans-1,4-cyclohexylene-(C₂-C₆)-alkane dicarboxylates such as, for example, poly(trans-1,4-cyclohexylene succinate, poly(trans-1,4-cyclohexylene adipate); poly(cis- or trans-1,4-cyclohexanedimethylene)alkanedicarboxylates such as, for example, poly(cis-1,4-cyclohexanedimethylene)oxalate, poly(cis-1,4-cyclohexanedimethylene)succinate; poly-(C₂-C₄)-alkylene terephthalates such as, for example, polyethylene terephthalate, polybutylene terephthalate, polytetramethylene terephthalate; poly-(C₂-C₄)-alkylene isophthalates such as, for example, polyethylene isophthalate, polytetramethylene isophthalate, or mixtures thereof.

Examples of polyesters which may be used in the present invention and which are currently commercially available are the products Vestodur® from Degussa Hüls.

Said thermoplastic polymer (a), either amorphous or crystalline, may optionally contain functional groups selected from: hydroxy groups, carboxylic groups, anhydride groups, ester groups, silane groups, epoxide groups. The amount of functional groups present in the thermoplastic polymer is generally between 0.05 and 50 parts by weight, preferably between 0.1 and 10 parts by weight, relative to 100 parts by weight of thermoplastic polymer (a).

The functional groups may be introduced during the production of the thermoplastic polymer (a), by copolymerization with corresponding functionalized monomers containing at least one ethylenic unsaturation, or by subsequent modification of the thermoplastic polymer (a) by grafting said functionalized monomers in the presence of a free-radical initiator (in particular an organic peroxide).

Functionalized monomers which may be used, for example, are: silanes containing at least one ethylenic unsaturation; epoxides containing at least one ethylenic unsaturation; monocarboxylic or, preferably, dicarboxylic acids containing at least one ethylenic unsaturation, or derivatives thereof, in particular anhydrides or esters.

Examples of silanes containing at least one ethylenic unsaturation are: γ-methacryloxypropyl-trimethoxysilane, allyltrimethoxysilane, allyltriethoxysilane, allylmethyldimethoxysilane, allylmethyldiethoxysilane, vinyltris(2-methoxy-ethoxy)silane, vinyltrimethoxysilane, vinylmethyldimethoxysilane, vinyltriethoxysilane, or mixtures thereof.

Examples of epoxides containing at least one ethylenic unsaturation are: glycidyl acrylate, glycidyl methacrylate, monoglycidyl ester of itaconic acid, glycidyl ester of maleic acid, vinyl glycidyl ether, allyl glycidyl ether, or mixtures thereof.

Examples of monocarboxylic or dicarboxylic acids containing at least one ethylenic unsaturation, or derivatives thereof, are: maleic acid, maleic anhydride, fumaric acid, citraconic acid, itaconic acid, acrylic acid, methacrylic acid, or mixtures thereof, and anhydrides or esters derived therefrom, or mixtures thereof.

According to one preferred embodiment, the diene elastomeric polymer (b) which may be used in the present invention may be selected from those commonly used in sulphur-crosslinkable elastomeric compositions, that are particularly suitable for producing tyres, that is to say from elastomeric polymers or copolymers with an unsaturated chain having a glass transition temperature (T_{g}) generally below 20° C., preferably in the range of from 0° C. to −90° C. These polymers or copolymers may be of natural origin or may be obtained by solution polymerization, emulsion polymerization or gas-phase polymerization of one or more conjugated diolefins, optionally blended with at least one comonomer selected from monovinylarenes and/or polar comonomers in an amount of not more than 60% by weight.

The conjugated diolefins generally contain from 4 to 12, preferably from 4 to 8 carbon atoms, and may be selected, for example, from the group comprising: 1,3-butadiene, isoprene, 2,3-dimethyl-1,3-butadiene, 1,3-pentadiene, 1,3-hexadiene, 3-butyl-1,3-octadiene, 2-phenyl-1,3-butadiene, or mixtures thereof. 1,3-butadiene and isoprene are particularly preferred.

Monovinylarenes which may optionally be used as comonomers generally contain from 8 to 20, preferably from 8 to 12 carbon atoms, and may be selected, for example, from: styrene; 1-vinylnaphthalene; 2-vinylnaphthalene; various alkyl, cycloalkyl, aryl, alkylaryl or arylalkyl derivatives of styrene such as, for example, α-methylstyrene, 3-methylstyrene, 4-propylstyrene, 4-cyclohexylstyrene, 4-dodecylstyrene, 2-ethyl-4-benzylstyrene, 4-p-tolylstyrene, 4-(4 phenylbutyl)styrene, or mixtures thereof. Styrene is particularly preferred.

Polar comonomers which may optionally be used may be selected, for example, from: vinylpyridine, vinylquinoline, acrylic acid and alkylacrylic acid esters, nitriles, or mixtures thereof, such as, for example, methyl acrylate, ethyl acrylate, methyl methacrylate, ethyl methacrylate, acrylonitrile, or mixtures thereof.

Preferably, the diene elastomeric polymer (b) which may be used in the present invention may be selected, for example, from: cis-1,4-polyisoprene (natural or synthetic, preferably natural rubber), 3,4-polyisoprene, polybutadiene (in particular polybutadiene with a high 1,4-cis content), optionally halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof.

The elastomeric composition according to the present invention may optionally comprise at least one elastomeric polymer of one or more monoolefins with an olefinic comonomer or derivatives thereof (c). The monoolefins may be selected from: ethylene and α-olefins generally containing from 3 to 12 carbon atoms, such as, for example, propylene, 1-butene, 1-pentene, 1-hexene, 1-octene, or mixtures thereof. The following are preferred: copolymers between ethylene and an α-olefin, optionally with a diene; isobutene homopolymers or copolymers thereof with small amounts of a diene, which are optionally at least partially halogenated. The diene optionally present generally contains from 4 to 20 carbon atoms and is preferably selected from: 1,3-butadiene, isoprene, 1,4-hexadiene, 1,4-cyclohexadiene, 5-ethylidene-2-norbornene, 5-methylene-2-norbornene, vinylnorbornene, or mixtures thereof. Among these, the following are particularly preferred: ethylene/propylene copolymers (EPR)- or ethylene/propylene/diene copolymers (EPDM); polyisobutene; butyl rubbers; halobutyl rubbers, in particular chlorobutyl or bromobutyl rubbers; or mixtures thereof.

A diene elastomeric polymer (b) or an elastomeric polymer (c) functionalized by reaction with suitable terminating agents or coupling agents may also be used. In particular, the diene elastomeric polymers obtained by anionic polymerization in the presence of an organometallic initiator (in particular an organolithium initiator) may be functionalized by reacting the residual organometallic groups derived from the initiator with suitable terminating agents or coupling agents such as, for example, imines, carbodiimides, alkyltin halides, substituted benzophenones, alkoxysilanes or aryloxysilanes (see, for example, European patent EP 451 604, or patents U.S. Pat. No. 4,742,124 and U.S. Pat. No. 4,550,142).

At least one reinforcing filler may advantageously be added to the elastomeric composition according to the present invention, in an amount generally of from 0.1 phr to 120 phr, preferably from 20 phr to 90 phr. The reinforcing filler may be selected from those commonly used for crosslinked manufactured products, in particular for tyres, such as, for example, carbon black, silica, alumina, aluminosilicates, calcium carbonate, kaolin, or mixtures thereof.

The types of carbon black which may be used according to the present invention may be selected from those conventionally used in the production of tyres, generally having a surface area of not less than 20 m²/g (determined by CTAB absorption as described in ISO standard 6810).

The silica which may be used according to the present invention may generally be a pyrogenic silica or, preferably, a precipitated silica, with a BET surface area (measured according to ISO standard 5794/1) of from 50 m²/g to 500 m²/g, preferably from 70 m²/g to 200 m²/g.

When a reinforcing filler comprising silica is present, the elastomeric composition may advantageously incorporate a coupling agent capable of interacting with the silica and of linking it to the diene elastomeric polymer during the vulcanization.

Coupling agents that are preferably used are those based on silane which may be identified, for example, by the following structural formula (II):
(R)₃Si—CₙH₂ₙ−X (II)
in which the groups R, which may be identical or different, are selected from: alkyl, alkoxy or aryloxy groups or from halogen atoms, on condition that at least one of the groups R is an alkoxy or aryloxy group; n is an integer between 1 and 6 inclusive; X is a group selected from: nitroso, mercapto, amino, epoxide, vinyl, imide, chloro, —(S)ₘCₙH₂ₙ—Si—(R)₃ in which m and n are integers between 1 and 6 inclusive and the groups R are defined as above.

Among the coupling agents that are particularly preferred are bis(3-triethoxysilylpropyl) tetrasulphide and bis(3-triethoxysilylpropyl) disulphide. Said coupling agents may be used as such or as a suitable mixture with an inert filler (for example carbon black) so as to facilitate their incorporation into the elastomeric composition.

The elastomeric composition according to the present invention may be vulcanized according to known techniques, in particular with sulphur-based vulcanizing systems commonly used for diene elastomeric polymers.

The vulcanizing agent most advantageously used is sulphur, or molecules containing sulphur (sulphur donors), with accelerators and activators known to those skilled in the art.

Activators that are particularly effective are zinc compounds, and in particular ZnO, ZnCO₃, zinc salts of saturated or unsaturated fatty acids containing from 8 to 18 carbon atoms, such as, for example, zinc stearate, which are preferably formed in situ in the elastomeric composition from ZnO and fatty acid, and also BiO, PbO, Pb₃O₄, PbO₂, or mixtures thereof.

Accelerators that are commonly used may be selected from: dithiocarbamates, guanidine, thiourea, thiazoles, sulphenamides, thiurams, amines, xanthates, or mixtures thereof.

The elastomeric composition according to the present invention may comprise other commonly used additives selected on the basis of the specific application for which the composition is intended. For example, the following may be added to said composition: antioxidants, anti-ageing agents, plasticizers, adhesives, anti-ozone agents, modifying resins, fibres (for example Kevlar® pulp), or mixtures thereof.

In particular, for the purpose of further improving the processability, a plasticizer generally selected from mineral oils, vegetable oils, synthetic oils, or mixtures thereof, such as, for example, aromatic oil, naphthenic oil, phthalates, soybean oil, or mixtures thereof, may be added to the elastomeric composition according to the present invention. The amount of plasticizer generally ranges from 2 phr to 100 phr, preferably from 5 phr to 50 phr.

The mixing of the masterbatch obtained in the pre-mixing step to the remainining portion of the diene elastomeric polymer (b), may be carried out discontinuosly or continuously.

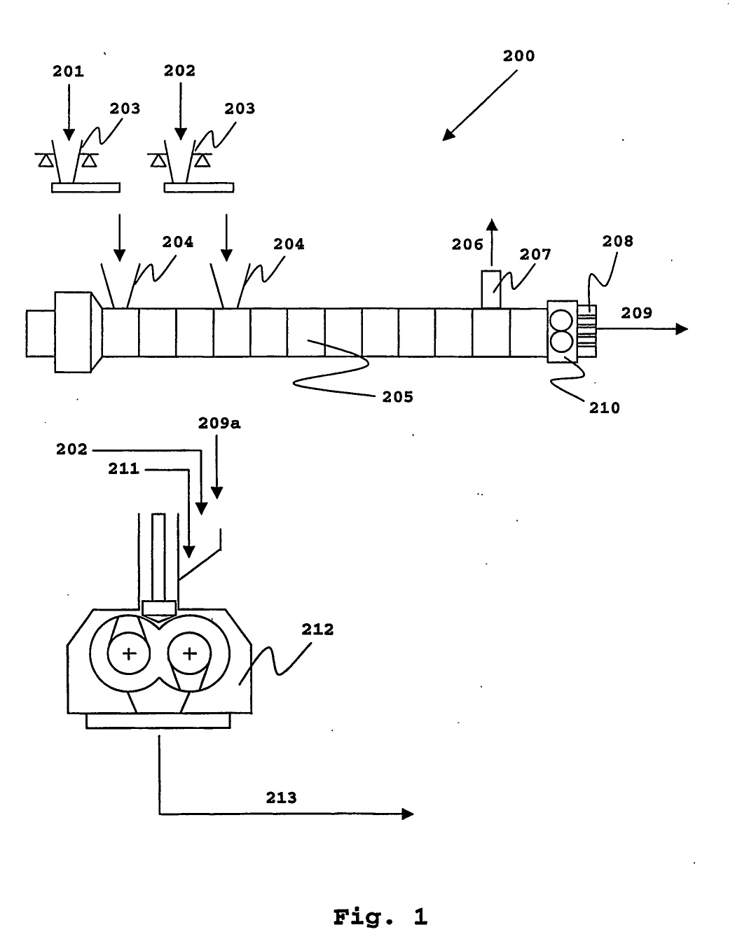

When the process is carried out discontinuosly (see FIG. 1), the mixing of the remaining portion of the diene elastomeric polymer (b) with the masterbatch of the thermoplastic polymer (a) and with the other components optionally present, is carried out, for example, using an open internal mixer such as an open mill, or an internal mixer of the type with tangential rotors (Banbury) or with interlocking rotors (Intermix).

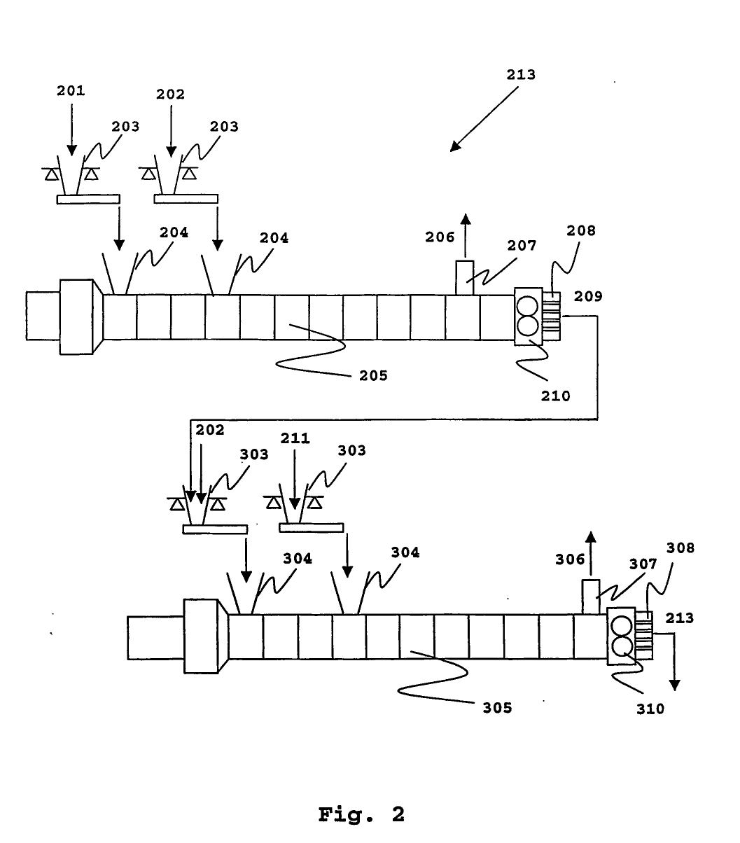

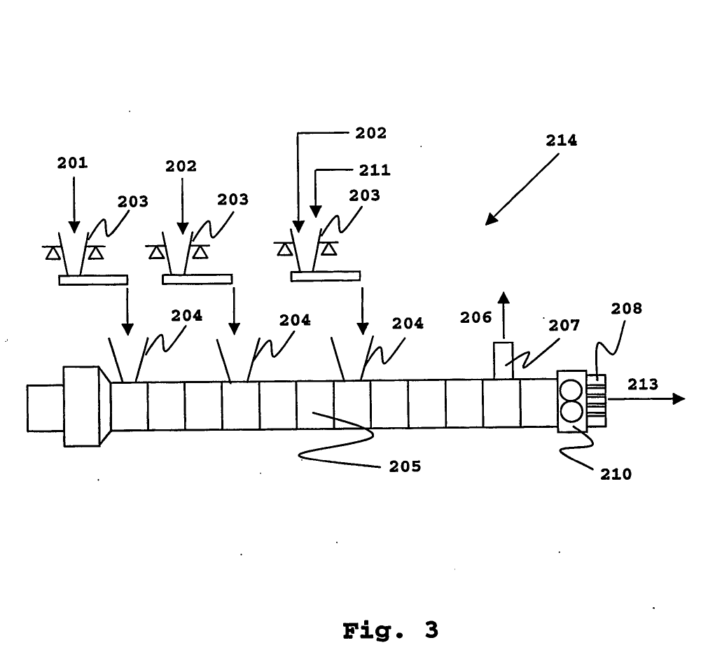

When said process is carried out continuously (see FIG. 2 and FIG. 3), the mixing of the diene elastomeric polymer (b) with the masterbatch of the thermoplastic polymer (a) and with the other components optionally present, is carried out, for example, using a continuous mixer such as a Ko-Kneader mixer (Buss) or using a co-rotating or a counter-rotating twin-screw extruder or a single-screw extruder.

During the mixing, the temperature is kept below a predetermined value so as to avoid premature crosslinking of the composition. To this end, the temperature is generally kept below 170° C., preferably below 150° C., even more preferably below 120° C. As regards the mixing time, this may vary within a wide range, depending mainly on the specific composition of the mixture, on the presence of reinforcing fillers and on the type of mixer used. In general, a mixing time of more than 10 seconds, preferably between 1 minute and 35 minutes is sufficient to obtain a homogeneous composition.

Preferably, the mixing is carried out in two steps. Preferably, an intermediate elastomeric composition is obtained (1^{st} step) by mixing the diene elastomeric polymer (b), the masterbatch of the thermoplastic polymer (a), the reinforcing fillers and the minor ingredients which are non temperature sensitive, namely, those ingredients which do not degrade and/or cause scorching at the operating conditions and/or do not interfere with the compounding process. Generally, said non temperature sensitive minor ingredients are all the minor ingredients except crosslinking agents, crosslinking accelerators, crosslinking retardants and crosslinking activators. For instance, it is to be avoided to use in the 1^{st} step those minor ingredients which can interfere with reactions that may occur during said 1^{st} step. For example, in the case of silica filled rubber mixtures, zinc derivatives (e.g. ZnO) and amine compounds should not be added during said 1^{st} step since they can interfere with the silanization reaction between the coupling agent and silica.

The present invention will now be illustrated in further detail by means of a number of illustrative embodiments, with reference to the attached figures wherein:

FIG. 1 is a schematic diagram of a batchwise production plant for producing an elastomeric composition according to the present invention;

FIG. 2 is a schematic diagram of a continuous production plant for producing an elastomeric composition according to the present invention;

FIG. 3 is a schematic diagram of a further embodiment of a continuous production plant for producing an elastomeric composition according to the present invention;

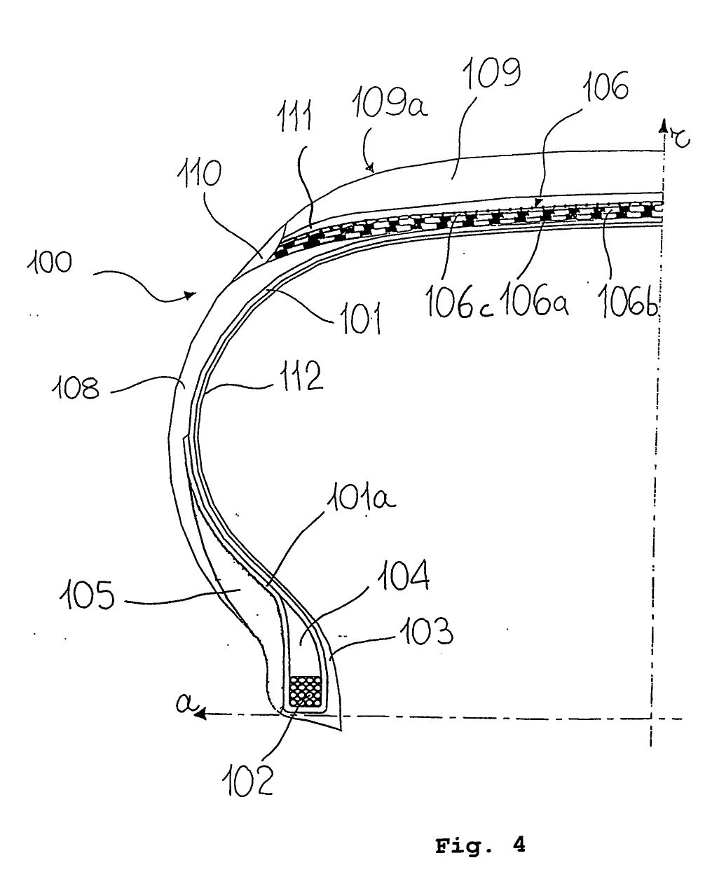

FIG. 4, is a view in cross section of a portion of a tyre made according to the invention.

With reference to FIG. 1, the batchwise production plant (200) includes an extruder (205) suitable for producing a masterbatch according to the present invention. As schematically shown in FIG. 1, by means of two feed hoppers (204) the extruder (205) is fed with the ingredients necessary for producing said desired masterbatch which tipically comprises the following ingredients: at least one thermoplastic polymers (a) and at least one diene elastomeric polymers (b), as defined above.

Preferably, the extruder (205) is a co-rotating twin screw extruder.

Generally, said ingredients are fed to different zone of the extruder. For example, FIG. 1 shows two main flows (201) and (202) in correspondence of two different zones of the extruder (205).

The same ingredient may be fed to the extruder in distinct portions, for example the same ingredient may be fed to two or more distinct zones of the extruder. For example, the diene elastomeric polymer (b) is fed to two distinct zones of the extruder. Therefore, each feed hopper may comprise more than one ingredient: for example, a portion of a diene elastomeric polymer (b) may be fed to the extruder (205) through the first feed hopper (204) together with the thermoplastic polymer (a), the remaining portion of said diene elastomeric polymer (b) being fed through the second feed hopper (204).

Each flow (201) and (202) are fed to the feed hoppers (204) by means of a metering device (203). Preferably, said metering device (203) is a loss-in-weight gravimetric feeder.

For simplicity, FIG. 1 shows only one metering device (203) for each flow (201) and (202). However in the case each flow comprises more than one ingredient, preferably each ingredient is provided with a dedicated metering device. Alternatively, a plurality of different ingredients may be metered by means of the same metering device.

Before being fed to the metering device (203), the diene elastomeric polymer (b) (202), which is usually provided by manufacturers in bales, is comminuted in irregular particles (crumbs) of small size (about 3 mm-15 mm as average dimensions), e.g. by of a rubber grinding (not represented in FIG. 1). The rubber crumbs may be then supplemented with an antisticking agent (e.g. chalk, silica, or other powders) to avoid reagglomeration.

The extruder (205) may optionally be provided with gravimetrically controlled feeding pumps (not represented in FIG. 1) which are useful to introduce into the extruder (205) plasticizing oils and possibly other liquid ingredients.

FIG. 1 shows also a degassing unit schematically indicated by reference sign (207) from which a flow (206) exits.

The masterbatch (209) is discharged from the extruder (205), e.g in the form of a subdivided product (209a) by pumping it through an extruder die (208) by means of a gear pump (210), said extruder die (208) being provided with a perforated die plate equipped with knives (not represent in FIG. 1). Alternatively, the masterbatch may be obtained in the form of a continues ribbon which may be then granulated by means of a grinding device (not represented in FIG. 1). The obtained product in subdivided form is then cooled, e.g. by conveying it to a cooling device (not represented in FIG. 1).

The obtained product in subdivided form (209a), the remaining portion of the diene elastomeric polymer (202) and the other additives optionally present (211), are then fed to an internal mixer (212) (e.g. a Banbury mixer) obtaining an elastomeric composition according to the present invention.

FIG. 2 represents a continuous production plant (213) wherein the step of obtaining the elastomeric composition is carried out in a second extruder (305). To this end, the product in subdivided form (209a) obtained as disclosed above, the remaining portion of a diene elastomeric polymer (b) (202) and the other additive optionally present (211), are fed to the second extruder through feed hoppers (304) by means of metering devices (303).

FIG. 2 shows also a degassing unit schematically indicated by reference sign (307) from which a flow (306) exits.

The elastomeric composition (213) is discharged from the extruder (305) by pumping it through an extruder die (308) by means of a gear pump (310) in the form of a continuous ribbon which may be transformed into a subdivided product operating as disclosed above (not represented in FIG. 2).

FIG. 3 is a further embodiment of a continuous production plant (214) wherein the elastomeric composition according to the present invention is carried out by means of a single extruder (205). To this end the thermoplastic polymer (a) (201) and a portion of the diene elastomeric polymer (b) (292) is fed to the extruder (205) through fed hoppers (204) by means of metering devices (203).

After mixing, the remaining portion of the diene elastomeric polymer (b) (202) and the other ingredient optionally present (211) are fed to the extruder (205) through a third feed hopper (204) by means of a metering device (203).

FIG. 3 shows also a flow (206) exiting from the extruder (205) which is generally provided with a degassing unit schematically indicated by reference sign (207).

The elastomeric composition (213) is discharged from the extruder (205) by pumping it through an extruder die (208) by means of a gear pump (210) in the form of a continuous ribbon which may be transformed into a subdivided product operating as disclosed above (not represented in FIG. 3).

With reference to FIG. 4, “a” indicates an axial direction and “r” indicates a radial direction. For simplicity, FIG. 4 shows only a portion of the tyre, the remaining portion not represented being identical and symmetrically arranged with respect to the radial direction “r”.

The tyre (100) comprises at least one carcass ply (101), the opposite lateral edges of which are associated with respective bead wires (102). The association between the carcass ply (101) and the bead wires (102) is achieved here by folding back the opposite lateral edges of the carcass ply (101) around the bead wires (102) so as to form the so-called carcass back-folds (101a) as shown in FIG. 4.

Alternatively, the conventional bead wires (102) can be replaced with a pair of circumferentially inextensible annular inserts formed from elongate components arranged in concentric coils (not represented in FIG. 4) (see, for example, European patent applications EP 928,680 and EP 928,702). In this case, the carcass ply (101) is not back-folded around said annular inserts, the coupling being provided by a second carcass ply (not represented in FIG. 4) applied externally over the first.

The carcass ply (101) generally consists of a plurality of reinforcing cords arranged parallel to each other and at least partially coated with a layer of elastomeric compound. These reinforcing cords are usually made of textile fibres, for example rayon, nylon or polyethylene terephthalate, or of steel wires stranded together, coated with a metal alloy (for example copper/zinc, zinc/manganese, zinc/molybdenum/cobalt alloys and the like).

The carcass ply (101) is usually of radial type, i.e. it incorporates reinforcing cords arranged in a substantially perpendicular direction relative to a circumferential direction. Each bead wire (102) is enclosed in a bead (103), defined along an inner circumferential edge of the tyre (100), with which the tyre engages on a rim (not represented in FIG. 4) forming part of a vehicle wheel. The space defined by each carcass back-fold (111a) contains a bead filler (104) in which the bead wires (102) are embedded. An antiabrasive strip (105) is usually placed in an axially external position relative to the carcass back-fold (101a).

A belt structure (106) is applied along the circumference of the carcass ply (101). In the particular embodiment in FIG. 4, the belt structure (106) comprises two belt strips (106a, 106b) which incorporate a plurality of reinforcing cords, typically metal cords, which are parallel to each other in each strip and intersecting with respect to the adjacent strip, oriented so as to form a predetermined angle relative to a circumferential direction. On the radially outermost belt strip (106b) may optionally be applied at least one zero-degree reinforcing layer (106c), commonly known as a “0° belt”, which generally incorporates a plurality of reinforcing cords, typically textile cords, arranged at an angle of a few degrees relative to a circumferential direction, and coated and welded together by means of an elastomeric material.

A side wall (108) is also applied externally onto the carcass ply (101), this side wall extending, in an axially external position, from the bead (103) to the end of the belt structure (106).

A tread band (109), whose lateral edges are connected to the side walls (108), is applied circumferentially in a position radially external to the belt structure (106). Externally, the tread band (109), which may be produced according to the present invention, has a rolling surface (109a) designed to come into contact with the ground. Circumferential grooves which are connected by transverse notches (not represented in FIG. 4) so as to define a plurality of blocks of various shapes and sizes distributed over the rolling surface (109a) are generally made in this surface (109a), which is represented for simplicity in FIG. 4 as being smooth.

A strip made of elastomeric material (110), commonly known as a “mini-side wall”, may optionally be present in the connecting zone between the side walls (108) and the tread band (109), this mini-side wall generally being obtained by co-extrusion with the tread band and allowing an improvement in the mechanical interaction between the tread band (109) and the side walls (108). Alternatively, the end portion of the side wall (108) directly covers the lateral edge of the tread band (109). A underlayer which forms, with the tread band (109), a structure commonly known as a “cap and base” (not represented in FIG. 4) may optionally be placed between the belt structure (106) and the tread band (109).

A layer of elastomeric material (111) which serves as an “attachment sheet”, i.e. a sheet capable of providing the connection between the tread band (109) and the belt structure (106), may be placed between the tread band (109) and the belt structure (106).

In the case of tubeless tyres, a rubber layer (112) generally known as a “liner”, which provides the necessary impermeability to the inflation air of the tyre, may also be provided in a radially internal position relative to the carcass ply (101).

The process for producing the tyre according to the present invention can be carried out according to techniques and using apparatus that are known in the art, as described, for example, in patents EP 199 064, U.S. Pat. No. 4,872,822, U.S. Pat. No. 4,768,937, said process including at least one step of manufacturing the green tyre and at least one step of vulcanizing this tyre.

More particularly, the process for producing the tyre comprises the steps of preparing, beforehand and separately from each other, a series of semi-finished products corresponding to the various parts of the tyre (carcass plies, belt structure, bead wires, fillers, side walls and tread band) which are then combined together using a suitable manufacturing machine. Next, the subsequent vulcanization step welds the abovementioned semi-finished products together to give a monolithic block, i.e. the finished tyre.

Naturally, the step of preparing the abovementioned semi-finished products will be preceded by a step of preparing and moulding the various crosslinkable elastomeric compositions of which said semi-finished products are made: said crosslinkable elastomeric composition may be prepared according to the present invention or according to conventional techniques.

The green tyre thus obtained is then passed to the subsequent steps of moulding and vulcanization. To this end, a vulcanization mould is used which is designed to receive the tyre being processed inside a moulding cavity having walls which are countermoulded to define the outer surface of the tyre when the vulcanization is complete.

Alternative processes for producing a tyre or parts of a tyre without using semi-finished products are disclosed, for example, in the abovementioned patent applications EP 928,680 and EP 928,702.

The green tyre can be moulded by introducing a pressurized fluid into the space defined by the inner surface of the tyre, so as to press the outer surface of the green tyre against the walls of the moulding cavity. In one of the moulding methods widely practised, a vulcanization chamber made of elastomeric material, filled with steam and/or another fluid under pressure, is inflated inside the tyre closed inside the moulding cavity. In this way, the green tyre is pushed against the inner walls of the moulding cavity, thus obtaining the desired moulding. Alternatively, the moulding can be carried out without an inflatable vulcanization chamber, by providing inside the tyre a toroidal metal support shaped according to the configuration of the inner surface of the tyre to be obtained as decribed, for example, in patent EP 242,840. The difference in coefficient of thermal expansion between the toroidal metal support and the crude elastomeric material is exploited to achieve an adequate moulding pressure.

At this point, the step of vulcanizing the crude elastomeric material present in the tyre is carried out. To this end, the outer wall of the vulcanization mould is placed in contact with a heating fluid (generally steam) such that the outer wall reaches a maximum temperature generally of between 100° C. and 230° C. Simultaneously, the inner surface of the tyre is heated to the vulcanization temperature using the same pressurized fluid used to press the tyre against the walls of the moulding cavity, heated to a maximum temperature of between 100° C. and 250° C. The time required to obtain a satisfactory degree of vulcanization throughout the mass of the elastomeric material can vary in general between 3 min and 90 min and depends mainly on the dimensions of the tyre. When the vulcanization is complete, the tyre is removed from the vulcanization mould.

The present invention will be further illustrated below by means of a number of preparation examples, which are given for purely indicative purposes and without any limitation of this invention.

### EXAMPLES 1-5

Preparation of the Masterbatches

Masterbatches were prepared by using a production plant as reported in FIG. 1.

Masterbatches were prepared by using styrene-butadiene copolymer (SBR) and the thermoplastic polymers as shown in Table 1 (the amounts are expressed as % by weight of the total).

TABLE 1

| | EXAMPLE | | | | |
|---|---|---|---|---|---|
| | 1 | 2 | 3 | 4 | 5 |
| SBR | 75 | 75 | 75 | 75 | 75 |
| Topas ® 6013 | 25 | — | — | — | — |
| Vestoran ® 1100 | — | 25 | — | — | — |
| Edistir ® 2560 | — | — | 25 | — | — |
| Vestodur ® 2000 | | | | 25 | — |
| Questra ® QA101 | — | — | — | — | 25 |

SBR: styrene/butadiene copolymer, obtained by emulsion polymerization, containing 40% by weight of styrene, mixed with 37.5% of oil (Europrene ® 1721 - EniChem Elastomeri);
Topas ® 6013: copolymer of norbornene and ethylene with norbornene content of 45% mol; T_{g} = 110° C.; (commercialized by Ticona);
Vestoran ® 1100: poly(2,6-dimethyl-1,4-phenylene ether); T_{g} = 116° C. (determined by ISO standard 306 - Vicat point); (commercialized by Degussa Hüls);
Edistir ® 2560: atactic polystyrene; T_{g} = 97° C. (determined by ISO standard 306 - Vicat point); (commercialized by Polimeri Europa);
Vestodur ® 2000: polyethylenetherephthalate; Tₘ = 221° C.-226° C.; (commercialized by Degussa Hüls);
Questra ® QA101: syndiotactic polystyrene; Tₘ = 273° C.; (commercialized by Dow Plastic).

The thermoplastic polymer, in the form of granules, was fed to the first feed hopper of a co-rotating twin-screw extruder Maris TM40HT having a nominal screw diameter of 40 mm and a L/D ratio of 48.

The SBR rubber copolymer was obtained in the form of granules, having an average particle size of about 3 mm-15 mm, by means of a rubber grinder.

In order to prevent reagglomeration, the obtained granules were dusted with silica.

Successively, the obtained granules were feed through a second and a third feed hopper (not represented in FIG. 1): specifically, 40% through a second feed hopper and 35% through a third feed hopper.

The feeding was carried out by means of a gravimetric feeder.

The working condition were the following:

### EXAMPLES 1-2

twin screw speed: 300 rpm;
temperature profile: 50-200-200-180-160-160-150-150-130-130-130-130° C.;
feeding rate 50 kg/h;
elastomeric composition temperature measured at twin screw discharge: 180° C.;

### EXAMPLE 3

twin screw speed: 300 rpm;
temperature profile: 50-180-180-180-160-160-150-150-130-130-130-130° C.;
feeding rate 50 kg/h;
elastomeric composition temperature measured at twin screw discharge: 180° C.;

### EXAMPLE 4

twin screw speed: 400 rpm;
temperature profile: 50-240-260-200-180-160-150-150-140-140-140-140° C.;
feeding rate 40 kg/h;
elastomeric composition temperature measured at twin screw discharge: 200° C.;

### EXAMPLE 5

twin screw speed: 500 rpm;
temperature profile: 200-270-340-250-200-260-180-180-150-150-150-150° C.;
feeding rate 30 kg/h.

The masterbatch was discharged from the extruder in the form of a subdivided product (209a) by pumping it through an extruder die by means of a gear pump, said extruder die being provided with a perforated die plate equipped with knives (not represent in FIG. 1). The obtained product in subdivided form was then conveyed by air to a cooling device (not represented in FIG. 1).

The masterbatches thus obtained were analyzed with an optical microscope in order to evaluate the dispersion of the thermoplastic polymer within the diene elastomeric polymer, according to the following method.

Preparation of Samples

A 3 g sample of each composition was pressure-molded in a Prestopress-Struers press (conditioning time=15 min; pressure=1 atm; maximum temperature=110° C.).

From the discs thus obtained, sections having a thickness of 5 μm were obtained using a Reichert-Jung 2050 microtome equipped with a LN20 cryogenic unit (cutting temperature: −70° C.). The sections thus obtained were placed on a slide previously cooled at −70° C.

Optical Analysis

The sections thus prepared were observed with a transmission optical microscope with polarized light (Polyvar Met model; 10× lenses, multiplication factor=1, equipped with polarizer and analyzer). Twenty images for each sample were memorized through a JVC TK1280E videocamera with a Y/C connecting cable. The images were computer-analyzed (by means of an Image Pro Plus—Media Cybernetic software) number of aggregates present in the field observed and the average diameter values of said aggregates (μm). The results are reported in Table 2.

TABLE 2

| | EXAMPLE | | | | |
|---|---|---|---|---|---|
| | 1 | 2 | 3 | 4 | 5 |
| Field | 13,000 | 13,000 | 13,000 | 13,000 | 13,000 |
| observed | | | | | |
| (mm²) | | | | | |
| Average | 64 | 80 | 102 | 80 | 64 |
| No. of | | | | | |
| aggregates | | | | | |
| Average | 10.5 | 12.5 | 10.5 | 13.6 | 16.2 |
| diameter | | | | | |
| (μm) | | | | | |

### EXAMPLES 6-12

Preparation of the Elastomeric Compositions

The elastomeric compositions given in Table 3 were prepared by using a production plant as reported in FIG. 1 (the amounts of the various components are given in phr).

All the ingredients, except for the sulphur and the accelerator, were mixed together in an internal mixer (of the laboratory type with tangential rotor (Banbury) model Pomini PL 1.6 for about 5 min (1^{st} Step). As soon as the temperature reached 145±5° C., the elastomeric composition was discharged. The sulphur and the accelerator were then added and mixing was carried out in an open roll mixer (2nd Step).

TABLE 3

| EXAMPLE | | | | | | |
|---|---|---|---|---|---|---|
| 6 (*) | 7 | 8 | 9 (*) | 10 | 11 | 12 |

1^{st} STEP

| | | | | | | | |
|---|---|---|---|---|---|---|---|
| SBR | 100 | 70 | 70 | 100 | 70 | 100 | 70 |
| Carbon black | 60 | 60 | 60 | 60 | 60 | 60 | 60 |
| Zinc oxide | 2.5 | 2.5 | 2.5 | 2.5 | 2.5 | 2.5 | 2.5 |
| Stearic acid | 1 | 1 | 1 | 1 | 1 | 1 | 1 |
| Vestoran ® | 10 | — | — | — | — | — | — |
| 1100 | | | | | | | |
| MB Vestoran ® | — | 40 | — | — | — | — | — |
| 1100 | | | | | | | |
| MB Topas ® | — | — | 40 | — | — | — | — |
| 6013⁽¹⁾ | | | | | | | |
| Edistir ® 2560 | — | — | — | 10 | — | — | — |
| MB Edistir ® | — | — | — | — | 40 | — | — |
| 2560 | | | | | | | |
| MB Questra ® | — | — | — | — | — | 40 | — |
| QA101⁽¹⁾ | | | | | | | |
| MB Vestodur ® | — | — | — | — | — | — | 40 |
| 2000⁽¹⁾ | | | | | | | |
| Antioxidant | 2 | 2 | 2 | 2 | 2 | 2 | 2 |

2^{nd} STEP

| | | | | | | | |
|---|---|---|---|---|---|---|---|
| CBS | 2 | 2 | 2 | 2 | 2 | 2 | 2 |
| Sulphur | 1 | 1 | 1 | 1 | 1 | 1 | 1 |

(*): comparative;
(¹): addition of thermoplastic polymer without the use of masterbatch gave highly disomogeneous composition which cannot be tested.
SBR: styrene/butadiene copolymer, obtained by emulsion polymerization, containing 40% by weight of styrene, mixed with 37.5% of oil (Europrene® 1721-EniChem Elastomeri);
Carbon black: N115 (Vulcan® 9-Cabot);
Vestoran® 1100: poly(2,6-dimethyl-1,4-phenylene ether); T_{g}=116° C. (determined by ISO standard 306-Vicat point); (commercialized by Degussa Huls);
MB Vestoran® 1100: masterbatch of Example-2;
MB Topas® 6013: masterbatch of Example 1;
Edistir® 2560: atactic polystyrene; T_{g}=97° C. (determined by ISO standard 306-Vicat point);
   (commercialized by Polimeri Europa);
MB Edistir® 2560: masterbatch of Example 3;
MB Questra® QA101: masterbatch of Example 5;
MB Vestodur® 2000: masterbatch of Example 4;
Antioxidant: phenyl-p-phenylenediamine;
CBS (accelerator): N-cyclohexyl-2-benzothiazyl-sulphenamide (Vulkacit® CZ-Bayer).

The static mechanical properties were measured on samples of the abovementioned elastomeric compositions vulcanized at 170° C. for 30 min, according to ISO standard 37: the obtained results are given in Table 4.

Table 4 also shows the dynamic mechanical properties, measured using an Instron dynamic device in the traction-compression mode according to the following methods. A test piece of the cross-linked material having a cylindrical form (length=25 mm; diameter=14 mm), compression-preloaded up to a 10% longitudinal deformation with respect to the initial length, and kept at the prefixed temperature (23° C., 100° C. or 120° C.) for the whole duration of the test, was submitted to a dynamic sinusoidal strain having an amplitude of ±3.33% with respect to the length under pre-load, with a 10 Hz frequency. The dynamic mechanical properties are expressed in terms of dynamic elastic modulus (E′) and tandelta (loss factor) values. As is known, the tandelta value is calculated as a ratio between the viscous modulus (E″) and the elastic modulus (E′), both of them being determined with the above dynamic measurements.

TABLE 4

| EXAMPLE | | | | | | |
|---|---|---|---|---|---|---|
| 6 (*) | 7 | 8 | 9 (*) | 10 | 11 | 12 |

STATIC MECHANICAL PROPERTIES

| | | | | | | | |
|---|---|---|---|---|---|---|---|
| Stress at break | n.d. | 16.1 | 15.3 | 15.5 | 15.9 | 16.4 | 15.2 |
| (MPa) | | | | | | | |

DINAMIC MECHANICAL PROPERTIES

| | | | | | | | |
|---|---|---|---|---|---|---|---|
| Tandelta (23° C.) | 0.420 | 0.480 | 0.480 | 0.470 | 0.479 | 0.450 | 0.380 |
| Tandelta (100° C.) | 0.270 | 0.299 | 0.307 | 0.345 | 0.349 | 0.284 | 0.220 |
| Tandelta (120° C.) | 0.230 | 0.287 | 0.301 | 0.224 | 0.230 | 0.215 | 0.190 |
| E′ (23° C.) | 19.0 | 19.60 | 20.83 | 20.32 | 20.66 | 17.39 | 20.25 |
| E′ (100° C.) | 6.8 | 6.99 | 7.36 | 5.30 | 5.40 | 7.71 | 9.55 |
| E′ (120° C.) | 5.6 | 5.79 | 5.79 | 4.70 | 4.60 | 7.34 | 9.27 |

(*): comparative;
n.d.: not determined.

The results given in Table 4 show that the crosslinked manufactured products comprising the masterbatch of the thermoplastic polymer according to the present invention have:
good stress at break (Examples 7, 8, 10, 11 and 12);
good hysteresis properties at high temperatures (Examples 7 and 8): consequently, the elastomeric compositions of Examples 7 and 8 allow to obtain a high roadholding at high temperatures.

1-34. (canceled)

35. A method for preparing a crosslinkable elastomeric composition:
wherein the composition comprises:
at least one thermoplastic polymer selected from amorphous polymers having a glass transition temperature (T_{g}) higher than 80° C. or crystalline polymers having a melting temperature (Tₘ) higher than 1900° C.; and
at least one diene elastomeric polymer; and
wherein the method comprises:
pre-mixing the at least one thermoplastic polymer with a first portion of the at least one diene elastomeric polymer to obtain a masterbatch, the pre-mixing being carried out at a temperature not lower than T_{g} or not lower than (Tₘ-20° C.); and
mixing the masterbatch with a remaining portion of the at least one diene elastomeric polymer.

36. The method of claim 35, wherein the first portion of the at least one diene elastomeric polymer is from 20%-by-weight to 90%-by-weight with respect to a total weight of the first and remaining portions of the at least one diene elastomeric polymer.

37. The method of claim 35, wherein the first portion of the at least one diene elastomeric polymer is from 30%-by-weight to 50%-by-weight with respect to a total weight of the first and remaining portions of the at least one diene elastomeric polymer.

38. The method of claim 35, wherein the at least one thermoplastic polymer is present in the elastomeric composition in an amount from 0.1 phr to 100 phr.

39. The method of claim 35, wherein the at least one thermoplastic polymer is present in the elastomeric composition in an amount from 3 phr to 60 phr.

40. The method of claim 35, wherein the at least one thermoplastic polymer is present in the elastomeric composition in an amount from 5 phr to 40 phr.

41. The method of claim 35, wherein the pre-mixing comprises:
feeding the at least one thermoplastic polymer into at least one extruder;
mixing the at least one thermoplastic polymer at a temperature not lower than T_{g} or not lower than (Tₘ−20° C.);
feeding the first portion of the at least one diene elastomeric polymer into the at least one extruder;
mixing the first portion of the at least one diene elastomeric polymer;
dispersing the at least one thermoplastic polymer into the first portion of the at least one diene elastomeric polymer to obtain the masterbatch; and
extruding the masterbatch through a discharge opening of the at least one extruder;
wherein the at least one extruder comprises:
a housing; and
at least one screw rotatably mounted in the housing; and
wherein the housing comprises:
at least one feed opening; and
the discharge opening.

42. The method of claim 41, wherein the at least one extruder comprises a co-rotating, twin-screw extruder.

43. The method of claim 41, wherein the masterbatch is obtained in a form of a continuous ribbon or in a form of a subdivided product.

44. The method of claim 41, wherein the at least one thermoplastic polymer is dispersed in the masterbatch in a form of particles having an average diameter not greater than 20 μm.

45. The method of claim 41, wherein the at least one thermoplastic polymer is dispersed in the masterbatch in a form of particles having an average diameter between 8 μm and 18 μm.

46. The method of claim 35, wherein the at least one thermoplastic polymer comprises one or more of: cycloolefin polymers, poly(phenylene ethers), styrene-based polymers, polyesters, polyamides, polyimides, polycarbonates, polysulfones, polyvinylchlorides, polymethyl(meth)acrylates, polyacrilonitriles, polyvinylpyrrolidones, aromatic polyketones, poly(alkylene oxides), aromatic polysulfides, and perfluorurated polyalkylenes.

47. The method of claim 35, wherein the at least one thermoplastic polymer comprises one or more of: cycloolefin polymers, poly(phenylene ethers), styrene-based polymers, and polyesters.

48. The method of claim 35, wherein the at least one thermoplastic polymer comprises at least one cycloolefin polymer, and
wherein the at least one cycloolefin polymer comprises one or more of:
a cycloolefin random copolymer obtained by copolymerizing (i) at least one aliphatic α-olefin and (ii) at least one cycloolefin represented by a following formula (I) and, optionally, (iii) a polyene;
a ring-opening polymer of at least one cycloolefin represented by the following formula (I); and
a hydrogenation product of a ring-opening polymer of at least one cycloolefin represented by the following formula (I): 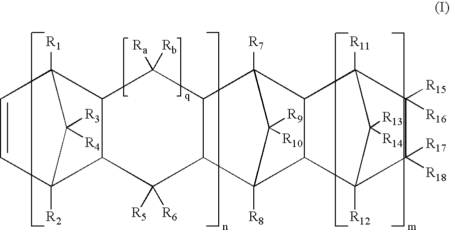
wherein:
n is 0 or a positive integer;
m is 0 or a positive integer;
q is 0 or 1;
R₁, R₂, R₃, R₄, R₅, R₇, R₈, R₉, R₁₀, R₁₁, R₁₂, R₁₃, R₁₄, R₁₅, R₁₆, R₁₇, R₁₈, Rₐ, and R_{b}, which may be equal to or different from each other, represent a hydrogen atom, a halogen atom, or an aliphatic, an alicyclic, or an aromatic hydrocarbon group;
R₁₅, R₁₆, R₁₇, and R₁₈ may be linked to each other to form a monocyclic or polycyclic group that may have double bonds; and
R₁₅ and R₁₆ or R₁₇ and R₁₈ may together form an alkylidene group.

49. The method of claim 48, wherein the at least one aliphatic α-olefin is an olefin of formula CH₂═CH—R, in which R represents a hydrogen atom or a linear or branched alkyl group containing from 1 to 12 carbon atoms.

50. The method of claim 47, wherein the poly(phenylene ethers) (PPE) are selected from thermoplastic engineering resins obtained by oxidative coupling polymerization of alkyl-substituted phenols.

51. The method of claim 50, wherein the thermoplastic engineering resins include poly(2,6-dialkyl-1,4-phenylene ethers).

52. The method of claim 47, wherein the styrene-based polymers have atactic configurations; syndiotactic configurations; isotactic configurations; atactic and syndiotactic configurations; atactic and isotactic configurations; syndiotactic and isotactic configurations; or atactic, syndiotactic, and isotactic configurations.

53. The method of claim 52, wherein the styrene-based polymers comprise one or more of: polystyrene, poly(alkylstyrene), poly(halogenated styrene), poly(halogenated alkylstyrene), poly(alkoxystyrene), poly(vinyl benzoate), hydrogenated polymers of polystyrene, hydrogenated polymers of poly(alkylstyrene), hydrogenated polymers of poly(halogenated styrene), hydrogenated polymers of poly(halogenated alkylstyrene), hydrogenated polymers of poly(alkoxystyrene), and hydrogenated polymers of poly(vinyl benzoate).

54. The method of claim 47, wherein the polyesters are selected from polymer reaction products of at least one aliphatic or aromatic polycarboxylic acid ester of anhydride and at least one diol.

55. The method of claim 54, wherein the polyesters comprise one or more of: poly(trans-1,4-cyclohexylene-(C₂-C₆)-alkane dicarboxylates; poly(cis- or trans-1,4-cyclohexanedimethylene)alkanedicarboxylates; and poly-(C₂-C₄)-alkylene terephthalates.

56. The method of claim 46, wherein the at least one thermoplastic polymer, either amorphous or crystalline, contains functional groups selected from: hydroxy groups, carboxylic groups, anhydride groups, ester groups, silane groups, and/or epoxide groups.

57. The method of claim 35, wherein the at least one diene elastomeric polymer has a glass transition temperature (T_{g}) below 20° C.

58. The method of claim 57, wherein the at least one diene elastomeric polymer comprises one or more of: cis-1,4-polyisoprene; 3,4-polyisoprene; polybutadiene; optionally halogenated isoprene/isobutene copolymers; 1,3-butadiene/acrylonitrile copolymers; styrene/1,3-butadiene copolymers; styrene/isoprene/1,3-butadiene copolymers; and styrene/1,3-butadiene/acrylonitrile copolymers.

59. The method of claim 35, wherein the elastomeric composition comprises at least one elastomeric polymer of one or more monoolefins with an olefinic comonomer or derivatives of the at least one elastomeric polymer of one or more monoolefins with an olefinic comonomer.

60. The method of claim 59, wherein the at least one elastomeric polymer comprises one or more of: ethylene/propylene copolymers (EPR) or ethylene/propylene/diene copolymers (EPDM); polyisobutene; butyl rubbers; and halobutyl rubbers.

61. The method of claim 35, wherein at least one reinforcing filler is present in the elastomeric composition in an amount between 0.1 phr and 120 phr.

62. The method of claim 61, wherein the at least one reinforcing filler comprises carbon black.

63. The method of claim 61, wherein the at least one reinforcing filler comprises silica.

64. An elastomeric composition, comprising:
from 1% to 65% of at least one thermoplastic polymer; and
from 35% to 99% of at least one diene elastomeric polymer;
wherein the at least one thermoplastic polymer is selected from amorphous polymers having a glass transition temperature (T_{g}) higher than 80° C. or crystalline polymers having a melting temperature (Tₘ) higher than 190° C., and
wherein the at least one thermoplastic polymer is dispersed in the elastomeric composition in a form of particles having an average diameter not greater than 20 μm.

65. The elastomeric composition of claim 64, comprising:
from 10% to 40% of the at least one thermoplastic polymer; and
from 60% to 90% of the at least one diene elastomeric polymer.

66. The elastomeric composition of claim 64, wherein the at least one thermoplastic polymer is dispersed in the elastomeric composition in the form of particles having an average diameter between 8 μm and 18 μm.

67. The elastomeric composition of claim 64, wherein the at least one thermoplastic polymer comprises one or more of: cycloolefin polymers, poly(phenylene ethers), styrene-based polymers, polyesters, polyamides, polyimides, polycarbonates, polysulfones, polyvinylchlorides, polymethyl(meth)acrylates, polyacrilonitriles, polyvinylpyrrolidones, aromatic polyketones, poly(alkylene oxides), aromatic polysulfides, and perfluorurated polyalkylenes.

68. The elastomeric composition of claim 64, wherein the at least one diene elastomeric polymer has a glass transition temperature (T_{g}) below 20° C.

69. The elastomeric composition of claim 68, wherein the at least one diene elastomeric polymer comprises one or more of: cis-1,4-polyisoprene; 3,4-polyisoprene; polybutadiene; optionally halogenated isoprene/isobutene copolymers; 1,3-butadiene/acrylonitrile copolymers; styrene/1,3-butadiene copolymers; styrene/isoprene/1,3-butadiene copolymers; and styrene/1,3-butadiene/acrylonitrile copolymers.
